(19) United States
(12) Patent Application Publication
(10) Pub. No.: US 2024/0042628 A1
(43) Pub. Date: Feb. 8, 2024

(54) Self-Balancing Articulated Arm for Delivering a Laser Beam

(71) Applicants: Robert David Biafore, Richmond Hill (CA); Mingfeng Zhang, Scarborough (CA); Sheelkumar Areshkumar Prajapati, North York (CA); Xing Yuan, Markham (CA)

(72) Inventors: Robert David Biafore, Richmond Hill (CA); Mingfeng Zhang, Scarborough (CA); Sheelkumar Areshkumar Prajapati, North York (CA); Xing Yuan, Markham (CA)

(21) Appl. No.: 17/817,977

(22) Filed: Aug. 5, 2022

(51) Int. Cl. B25J 19/00; G02B 17/00

(52) U.S. Cl. CPC B25J 19/0016; G02B 17/008

(57) ABSTRACT

The present disclosure provides an apparatus for delivering a laser beam from a stationary end to a movable end. One exemplary apparatus comprises multiple segments of articulated tubes with mirrors encapsulated inside the tubes for deflecting the laser beams and a self-balancing suspension system to support this beam delivery system to allow at least one of its ends to be movable.

### RELATED APPLICATIONS

Provisional application No. 63/233,725, filled on Aug. 16, 2021.

### FIELD OF THE INVENTION

The present invention relates generally to an apparatus for delivering a laser beam from a stationary end to a movable end and, more particularly, an apparatus comprising a self-balancing articulated arm for delivering laser beam form a stationary end to a movable end.

### BACKGROUND OF THE INVENTION

A beam delivery system is a device for transmitting a laser beam from its source to a laser head that projects the beam to a workpiece. Optical fibers are generally a preferred option for beam delivery because of their flexibility. This flexibility is especially beneficial for applications where the laser head needs to move. However, optical fibers cannot transmit a laser beam with a wavelength longer than 2600 nanometers due to high absorption rate of fibers. CO₂ laser is an example of laser that cannot be delivered by optical fibers. Instead, CO₂ laser is generally delivered by reflective mirrors that are often encapsulated in tubes.

Additionally, many applications of CO₂ laser, such as welding, require the laser head to be moved by an automated machine such as a robot arm around a workpiece. Such applications generally require the laser head be capable of six degrees of freedom of movement to cover the entire surface of the workpiece. This adds another level of complexity to beam delivery of CO₂ laser because the mirror-based delivery approach shall avoid restricting motion of the robotic arm. To that end, CO₂ laser is generally delivered by the so-called articulated arm mechanism. An articulated beam delivery system for CO₂ laser comprises a set of tubes that are connected one to another by rotatable joints or couplers and mirrors that are installed at joints or couplers to direct a laser beam from one tube to another tube.

When the laser head is carried and moved by an automated machine such as a robot arm, the corresponding articulated beam delivery system needs to behavior as a passive arm that moves with a robot arm. Since it is passive, it must be properly suspended to avoid limiting the robot arm's motion and to prevent colliding with the robot arm. One common mechanism for suspending articulated beam delivery systems involves using a tool balancer to provide suspension from a higher position. This works well in many applications, but it requires a structure or a supporting point above the system to attach the balancer. Therefore, this may not be suitable if a compact design is desired or if there is insufficient space above the system.

Another category of mechanisms for suspending articulated beam delivery systems uses either a counterweight or gas springs in a lever configuration. One example (U.S. Pat. No. 4,473,074) disclosed in prior art employs a counterweight to balance a structure to support an articulated beam delivery system in which the movable end is manually guided by a human operator. Another example (U.S. Pat. No. 7,951,139) disclosed in prior art provides a lever mechanism, which is supported by a gas spring, for suspending an articulated delivery system.

The solutions provided in these disclosures are small scale and unable to support heavy articulated beam delivery systems. Besides, these mechanisms overlooked the need to reduce the bending load on the beam delivery structure. For application involving high-power laser, the articulated beam delivery systems tend to be heavy and large, and minimizing the bending load on the delivery structure is critical to maintaining beam alignment. In short, the articulated beam delivery systems disclosed in prior art are inadequate in terms of their capability of reducing bending load, and there is a need for an improved mechanism for delivering high-power laser and suspending articulated delivery systems.

### SUMMARY OF THE INVENTION

The present disclosure provides an articulated beam delivery system with a compact, flexible, and strong suspension mechanism. The present system is a self-balancing structure, and it is designed to minimize the deflection of its structures. The present articulated delivery system and its suspension structure form a four-bar parallelogram mechanism that is balanced by a gas spring. The gas spring connects a top linkage and a fixed linkage of the parallelogram to make it self-balanced. The lower linkage of this mechanism is a hollow tube for a laser beam to pass through. Mirrors inside joints at both ends of this tube deflect the laser beam from or to connecting tubes. The weight of the hollow tube is borne by the top linkage; therefore, it is less likely to deflect under its own weight or the weight of other members of the system. This helps greatly for preventing misalignment between internal mirrors, thus allowing for long-term operation of the system without the need to realign of the mirrors frequently.

### BRIEF DESCRIPTION OF DRAWINGS

Embodiments will now be described, by way of example only, with reference to the drawings, in which:

FIG. 1 shows a schematic illustration of the components of the articulated beam delivery system and its suspension structure according to an embodiment of the invention.

FIG. 2 shows a close-up illustration of the components near the base of the articulated beam delivery system and is suspension structure according to an embodiment of the invention.

### DETAILED DESCRIPTION OF THE INVENTION

Various embodiments and aspects of the disclosure will be described with reference to details discussed below. The following description and drawings are illustrative of the disclosure and are not to be construed as limiting the disclosure. The drawings are not necessarily to scale. Numerous specific details are described to provide a thorough understanding of various embodiments of the present disclosure. However, in certain instances, well-known or conventional details are not described in order to provide a concise discussion of embodiments of the present disclosure.

As used herein, the terms, “comprises” and “comprising” are to be construed as being inclusive and open ended, and not exclusive. Specifically, when used in this specification including claims, the terms, “comprises” and “comprising” and variations thereof mean the specified features, steps or components are included. These terms are not to be interpreted to exclude the presence of other features, steps, or components.

As used herein, the term “exemplary” means “serving as an example, instance, or illustration,” and should not be construed as preferred or advantageous over other configurations disclosed herein.

As used herein, the terms “about” and “approximately”, when used in conjunction with ranges of dimensions of particles, compositions of mixtures or other physical properties or characteristics, are meant to cover slight variations that may exist in the upper and lower limits of the ranges of dimensions so as to not exclude embodiments where on average most of the dimensions are satisfied but where statistically dimensions may exist outside this region. It is not the intention to exclude embodiments such as these from the present disclosure.

The present disclosure relates to an articulated beam delivery system and its suspension structure for transmitting a laser beam from a stationary source to a movable end. As required, preferred embodiments of the invention will be disclosed, by way of examples only, with reference to drawings. It should be understood that the invention can be embodied in many various and alternative forms. In other instances, well-known methods, procedures, and components have not been described in detail so as not to obscure the embodiments described herein. Also, the description is not to be considered as limiting the scope of the embodiments described herein.

The structure of the articulated beam delivery system and its suspension structure will first be described.

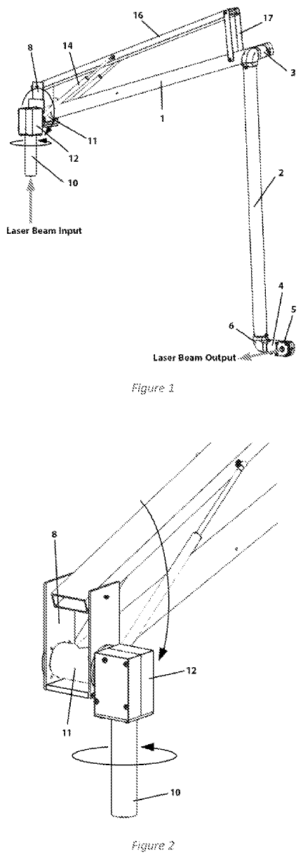

Referring to FIG. 1 and FIG. 2, the present articulated beam delivery system is shown generally according to one embodiment of the invention. Said apparatus includes a tube 10, which could be attached fixedly to a laser source, and a launch housing 12, which is connected to tube 10 through a coupler that permits rotation of launch housing 12 with respect to tube 10 around the longitudinal axis of tube 10. Said apparatus further includes a second tube 11 that is coupled to said launch housing 12 with its longitudinal axis perpendicular to the longitudinal axis of tube 10, and the coupler between tube 11 and housing 12 permits rotation of tube 11 with respect to housing 12 around the longitudinal axis of tube 11. A reflective mirror is installed in launch housing 12 for directing a laser beam from the opening of tube 10 to tube 11. A third tube 1 is coupled to tube 11 fixedly, and a second mirror being installed in tube 11 further directs the laser beam from tube 11 to tube 1. Said apparatus further includes a first linkage 8 that is coupled to housing 12 and is permitted to rotate around the longitudinal axis of tube 11 independently from the rotation of tube 11. Linkage 8 is further coupled to a second linkage 16, which is permitted to rotate with respect to linkage 8 around an axis that parallel to the longitudinal axis of tube 11. Linkage 16 is further coupled with a third linkage 17, which is permitted to rotate with respect to linkage 16 around an axis that is parallel to the longitudinal axis of tube 11. Linkage 17 is further coupled to a tube 1, where tube 1 is permitted to rotate with respect to linkage 17 around an axis that is parallel to the longitudinal axis of tube 11. Said apparatus further includes one or more springs 14 connecting said second linkage 16 and said first linkage 8. The coupling between spring 14 and linkage 16 permits relative rotation of these two elements around axis that is parallel to the longitudinal axis of tube 11.

Said tube 1, linkage 17, linkage 8, and linkage 16 form a parallelogram mechanism that is supported by spring 14. Linkage 16 bears the weight of tubes 1, 2, and 4. The spring 14 is sized such that it bears the total weight of the articulated arm including linkage 16. The spring 14 is also sized such that the stroke of the spring 14 allows for a desired range of rotation of tube 1 around the longitudinal axis of tube 11.

In a preferred embodiment, said spring 14 is a gas spring or an air spring.

Said articulated arm may further comprise a few additional articulated elements connecting to tube 1 for providing six or higher degrees of freedom for the end of said articulated arm. The configuration of these additional articulated elements is very similar to articulated arms disclosed in prior art. Continuing with reference to FIG. 1, an exemplary configuration of such additional articulated elements is described as follows. A tube 2 is connected to tube 1 by another coupler 3 containing two mirrors for reflecting a laser beam from tube 1 to tube 2. Coupler 3 is rotatable around the longitudinal axis of tube 1 and permits rotation of tube 2 around an axis perpendicular to the longitudinal axis of tube 1. An additional tube 4 is connected to tube 2 by another coupler 6. Coupler 6 contains one mirror for reflecting a laser beam from tube 2 to tube 4. Coupler 6 is rotatable around the longitudinal axis of tube 2 and allows tube 4 to rotate around an axis perpendicular to the longitudinal axis of tube 2. An additional coupler 5 is connected to tube 4 and is rotatable around the longitudinal axis of tube 4. Said coupler 5 contains one mirror for directing a laser beam from tube 4 to a direction perpendicular to the longitudinal axis of tube 4. Coupler 5 has a flange from which a laser beam is delivered and to which a laser head can be attached for project the laser beam to a target.

The specific embodiments described above have been shown by way of example, and it should be understood that these embodiments may be susceptible to various modifications and alternative forms.

Therefore, what is claimed is:

1. A laser beam delivery system for transmitting a laser beam from a stationary end to a movable end comprises:
a first tube;
a launch housing;
a first coupler connecting said first tube and said launch housing and permitting said launch housing to rotate around the longitudinal axis of said first tube;
a second tube;
a second coupler connecting said launch housing and said second tube with its longitudinal axis perpendicular to the longitudinal axis of said first tube and permitting said second tube to rotate around its longitudinal axis with respect to the launch housing;
a first reflective mirror installed in said launch housing for reflecting a laser beam from the opening of said first tube to said second tube;
a third tube coupled to said second tube fixedly and having its longitudinal axis perpendicular to the longitudinal axis of said second tube;
a second mirror installed in said second tube for reflecting a laser beam from said second tube to said third tube;
a first linkage coupled to said launch housing and being rotatable around the longitudinal axis of said second tube;
a second linkage and a third linkage, where said second linkage is coupled to said first linkage and said third linkage and is rotatable with respect to said first linkage around an axis that is parallel to the longitudinal axis of said second tube, said third linkage is rotatable with respect to said second linkage around an axis that is parallel to the longitudinal axis of said second tube, and said third linkage is coupled with said third tube and is rotatable with respect to said third tube around axis that is parallel to the longitudinal axis of said second tube;
one or more springs connecting said second linkage and said first linkage, where the couplings between said one or more springs and said second linkage permit the relative rotation of said one or more springs and said second linkage around an axis that is parallel to the longitudinal axis of said second tube.

2. The system according to claim 1, wherein said one or more springs are any one of a gas spring, an air spring, and a combination of thereof.

3. The system according to claim 1 may further comprises:
a fourth tube;
a third coupler connecting said fourth tube and said third tube, containing two mirrors for reflecting a laser beam from said third tube to said fourth tube, rotatable around the longitudinal axis of said third tube, and permitting said fourth tube to rotate around any axis that is perpendicular to the longitudinal axis of said third tube;
a fifth tube;
a fourth coupler connecting said fifth tube and said fourth tube, containing one mirror for reflecting a laser beam from said fourth tube to said fifth tube, and permitting said fifth tube to rotate around the longitudinal axis of said fourth tube;
a fifth coupler coupled with said fifth tube, rotatable around the longitudinal axis of said fifth tube, containing one mirror for reflecting a laser beam from said fifth tube to a direction that is perpendicular to the longitudinal axis of said fifth tube.

4. The system according to claim 3, where in said fifth coupler may further comprises a flange.
